(19) United States
(12) Patent Application Publication
(10) Pub. No.: US 2026/0081530 A1
(43) Pub. Date: Mar. 19, 2026

(54) Buck-Boost Power Converter and Control Method

(71) Applicant: Diodes Incorporated, Plano, TX (US)

(72) Inventors: Hao-Ming Chen, New Taipei City (TW); Feng-Jung Huang, Taoyuan City (TW); Ko-Yen Lee, New Taipei City (TW)

(21) Appl. No.: 18/889,133

(22) Filed: Sep. 18, 2024

(51) Int. Cl. H02M 3/158; H02M 1/00

(52) U.S. Cl. CPC H02M 3/1582; H02M 1/0009; H02M 1/0025; H02M 1/0093

(57) ABSTRACT

An apparatus includes a clock generator configured to generate a set signal fed into a set input of a latch, an error amplifier configured to generate a COMP signal, an offset generator configured to generate different offset voltages, and a comparator configured to generate a reset signal fed into a reset input of the latch, wherein a non-inverting input of the comparator is configured to receive a signal equal to a sum of a current sense signal and a slope compensation signal, and wherein the current sense signal is equal to a current flowing through a power converter times an adjustable gain, and an inverting input of the comparator is configured to receive an error signal, and wherein the error signal is equal to the COMP signal minus an offset voltage generated by the offset generator.

### TECHNICAL FIELD

The present disclosure relates generally to the field of power converters, and in particular embodiments, to techniques and mechanisms for a buck-boost power converter.

### BACKGROUND

A power converter transforms an input voltage into a regulated output voltage and delivers the required current to an external load, such as integrated circuits. Power converters can be classified into two types: isolated and non-isolated, based on whether a transformer is used. Isolated power converters utilize various topologies, including flyback, forward, half-bridge, full-bridge, push-pull, and inductor-inductor-capacitor (LLC) resonant converters. Similarly, non-isolated power converters employ topologies such as buck, boost, buck-boost converters, linear regulators, and their combinations.

As the demand for battery-powered applications has increased, there is a growing need for converters that can generate a regulated output voltage from an input voltage that may be higher, equal to, or lower than the output voltage. For instance, in a battery-powered system, a fresh battery may provide a voltage higher than the output voltage of a power converter, while a depleted battery may provide a voltage lower than the output voltage of the power converter. Buck-boost converters have proven to be an efficient solution for delivering a tightly regulated output voltage across a wide input voltage range. These converters can generate an output voltage either higher or lower than the input voltage by operating in different modes. Specifically, the buck-boost converter operates in a buck operating mode when the input voltage exceeds the output voltage. The buck-boost converter operates in in a boost operating mode when the input voltage is lower than the output voltage. The buck-boost converter operates in in a buck-boost operating mode when the input voltage is approximately equal to the output voltage.

Control schemes like peak current mode control allow power converters to regulate the output effectively. This method uses both voltage and current feedback to control the peak inductor current during each switching cycle. The output voltage is compared to a reference, generating an error signal that sets the peak current threshold. Once the inductor current reaches this threshold, the high-side switch turns off. This process repeats for each cycle. This approach offers faster transient response, simpler compensation design, and improved current limiting compared to voltage-mode control. However, at high duty cycles, it may become unstable, requiring slope compensation for proper operation.

In buck-boost converters using peak current mode control, the error signal temporarily drops during a transition between two different operating modes. The COMP signal, responsible for stabilization, cannot quickly adjust through a standard feedback and compensation circuit, leading to instability in the output voltage during operating mode transitions. An apparatus or method that allows a smooth operating mode transition in four-switch buck-boost converters with peak current mode control would be highly beneficial, and this disclosure addresses that need.

### SUMMARY

Technical advantages are generally achieved, by embodiments of this disclosure which describe a buck-boost power converter.

In accordance with an embodiment, an apparatus comprises a clock generator configured to generate a set signal fed into a set input of a latch, an error amplifier configured to generate a COMP signal, an offset generator configured to generate different offset voltages in response to different operating modes, and a comparator configured to generate a reset signal fed into a reset input of the latch, wherein a non-inverting input of the comparator is configured to receive a signal equal to a sum of a current sense signal and a slope compensation signal, and wherein the current sense signal is equal to a current flowing through a power converter times an adjustable gain, and an inverting input of the comparator is configured to receive an error signal, and wherein the error signal is equal to the COMP signal minus an offset voltage generated by the offset generator.

In accordance with another embodiment, a system comprises a four-switch buck-boost converter comprising a first high-side switch, a first low-side switch, a second high-side switch, a second low-side switch and an inductor, and a controller configured to generate four gate drive signals for controlling four switches of the four-switch buck-boost converter, respectively, wherein the controller comprises a clock generator configured to generate a set signal fed into a set input of a latch, an error amplifier configured to generate a COMP signal, an offset generator configured to generate different offset voltages, and a comparator configured to generate a reset signal fed into a reset input of the latch, wherein a non-inverting input of the comparator is configured to receive a signal equal to a sum of a current sense signal and a slope compensation signal, and wherein the current sense signal is equal to a current flowing through the inductor times an adjustable gain, and an inverting input of the comparator is configured to receive an error signal, and wherein the error signal is equal to the COMP signal minus an offset voltage generated by the offset generator.

In accordance with yet another embodiment, a method comprises feeding a clock signal into a set input of a latch, generating a COMP signal based on a comparison between a detected output voltage signal and a predetermined reference, in response to an operating mode of a four-switch buck-boost converter, subtracting a corresponding offset voltage from the COMP signal to obtain an error signal, generating a reset signal based on a comparison between the error signal and a current signal, wherein the current signal is equal to a sum of a current sense signal generated by a variable gain amplifier and a slope compensation signal, and based on an output signal of the latch, generating four gate drive signals for controlling four switches of the four-switch buck-boost converter, respectively.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 illustrates a block diagram of a power converter in accordance with various embodiments of the present disclosure;

FIG. 2 illustrates a schematic diagram of a four-switch buck-boost converter with peak current mode control in accordance with various embodiments of the present disclosure;

FIG. 3 illustrates the variation of the error signal under different operating modes in accordance with various embodiments of the present disclosure;

FIG. 4 illustrates various waveforms associated with the buck operating mode of the four-switch buck-boost converter in accordance with various embodiments of the present disclosure;

FIG. 5 illustrates various waveforms associated with the buck-boost operating mode of the four-switch buck-boost converter in accordance with various embodiments of the present disclosure;

FIG. 6 illustrates various waveforms associated with the boost operating mode of the four-switch buck-boost converter in accordance with various embodiments of the present disclosure;

FIG. 7 illustrates a schematic diagram of a four-switch buck-boost converter and a peak current mode controller in accordance with various embodiments of the present disclosure;

FIG. 8 illustrates the variations of the COMP signal and the error signal under different operating modes in accordance with various embodiments of the present disclosure; and

FIG. 9 illustrates a flow chart of a method for controlling the four-switch buck-boost converter shown in FIG. 7 in accordance with various embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Further, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

The present disclosure will be described with respect to embodiments in a specific context, namely a four-switch buck-boost power converter. The disclosure may also be applied, however, to a variety of power converters. Hereinafter, various embodiments will be explained in detail with reference to the accompanying drawings.

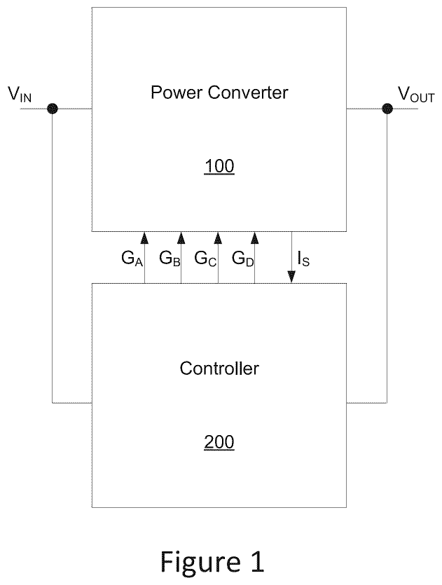

FIG. 1 illustrates a block diagram of a power converter in accordance with various embodiments of the present disclosure. The power converter 100 is connected between an input volage bus V_{IN} and an output voltage bus V_{OUT}. In some embodiments, the power converter 100 is a four-switch buck-boost converter. Throughout the description, the power converter 100 may be alternatively referred to as a four-switch buck-boost converter. A controller 200 is configured to receive an input voltage, an output voltage and a current sense signal I_{S}. Based on the received signals, the controller 200 is able to generate four gate drive signals G_{A}, G_{B}, G_{C} and G_{D} for controller the four switches of the power converter 100, respectively.

In some embodiments, the power converter 100 comprises a first high-side switch, a first low-side switch, a second high-side switch, a second low-side switch, an inductor and a current sense device. In some embodiments, the current sense device is implemented as a current sense resistor. The first high-side switch and the first low-side switch are connected in series between V_{IN} and ground. The second high-side switch and the second low-side switch are connected in series between V_{OUT} and ground. The inductor and the current sense device are connected in series between a common node of the first high-side switch and the first low-side switch, and a common node of the second high-side switch and the second low-side switch.

In some embodiments, the controller 200 comprises a clock generator, an error amplifier, an offset generator and a comparator. The clock generator is configured to generate a set signal fed into a set input of a latch. The error amplifier is configured to generate a COMP signal. The offset generator is configured to generate different offset voltages. The comparator is configured to generate a reset signal fed into a reset input of the latch. A non-inverting input of the comparator is configured to receive a signal equal to a sum of a current sense signal and a slope compensation signal. The current sense signal is equal to a current flowing through the inductor times an adjustable gain. An inverting input of the comparator is configured to receive an error signal. The error signal is equal to the COMP signal minus an offset voltage generated by the offset generator. More particularly, in a buck operating mode of the power converter 100, the offset voltage is set to zero. The error signal is equal to the COMP signal. In a buck-boost operating mode of the power converter 100, the error signal is equal to the COMP signal minus a first offset voltage generated by the offset generator. In a boost operating mode of the power converter 100, the error signal is equal to the COMP signal minus a sum of a first offset voltage and a second offset voltage generated by the offset generator.

The power converter 100 further comprises a variable gain amplifier. The variable gain amplifier is employed to amplify the current sense signal to a level that can be processed by the controller 200. In some embodiments, the variable gain amplifier is integrated with the controller 200. In alternative embodiments, the variable gain amplifier is a separate device located outside the controller 200.

A non-inverting input of the variable gain amplifier is connected to a first terminal of the current sense resistor. An inverting input of the variable gain amplifier is connected to a second terminal of the current sense resistor. An output of the variable gain amplifier is configured to generate the current sense signal.

The controller 200 further comprises a control logic unit. An input of the control logic unit is connected to an output of the latch. The control logic unit is configured to generate the four gate drive signals G_{A}, G_{B}, G_{C} and G_{D} for controlling four switches of the power converter 100, respectively. Furthermore, the control logic unit is configured to receive an input voltage and an output voltage of the power converter 100. Based on the received input and output voltages, the control logic unit is able to generate a first control signal indicative of a buck-boost operating mode of the power converter 100 and a second control signal indicative of a boost operating mode of the power converter 100.

The offset generator comprises a first offset processing unit and a first control switch connected in series, and a second offset processing unit and a second control switch connected in series. The first offset processing unit is configured to receive the output voltage and generate a first offset voltage. The second offset processing unit is configured to receive the output voltage and generate a second offset voltage.

The power converter 100 is configured to operate in three different operating modes. According to the voltage transfer function of each operating mode, the error signal comprises three variables including the current flowing through the inductor, the output voltage and a constant. By applying different current sense gains, the current variable can be excluded from the error signal. Once the current variable is removed, the error signal is simplified to only include the output voltage and the constant. As a result, an ideal error signal can be achieved by subtracting an offset voltage from the COMP signal during transitions between operating modes.

In operation, in response to a buck operating mode of the four-switch buck-boost converter, the variable gain amplifier is configured to amplify the current flowing through the inductor to generate a first amplified current sense signal having a first gain. In response to a buck-boost operating mode of the four-switch buck-boost converter, the variable gain amplifier is configured to amplify the current flowing through the inductor to generate a second amplified current sense signal having a second gain. In response to a boost operating mode of the four-switch buck-boost converter, the variable gain amplifier is configured to amplify the current flowing through the inductor to generate a third amplified current sense signal having a third gain.

In operation, in response to the buck operating mode of the power converter 100, both the first control switch and the second control switch are turned off. As a result of turning off both the first control switch and the second control switch, the error signal fed into the comparator is equal to the COMP signal generated by the error amplifier. In response to the buck-boost operating mode of the power converter 100, the first control switch is turned on and the second control switch is turned off. As a result of turning on the first control switch and turning off the second control switch, the first offset voltage is subtracted from the COMP signal to obtain the error signal fed into the comparator. In response to the boost operating mode, both the first control switch and the second control switch are turned on. As a result of turning on both the first control switch and the second control switch, a sum of the first offset voltage and the second offset voltage is subtracted from the COMP signal to obtain the error signal fed into the comparator.

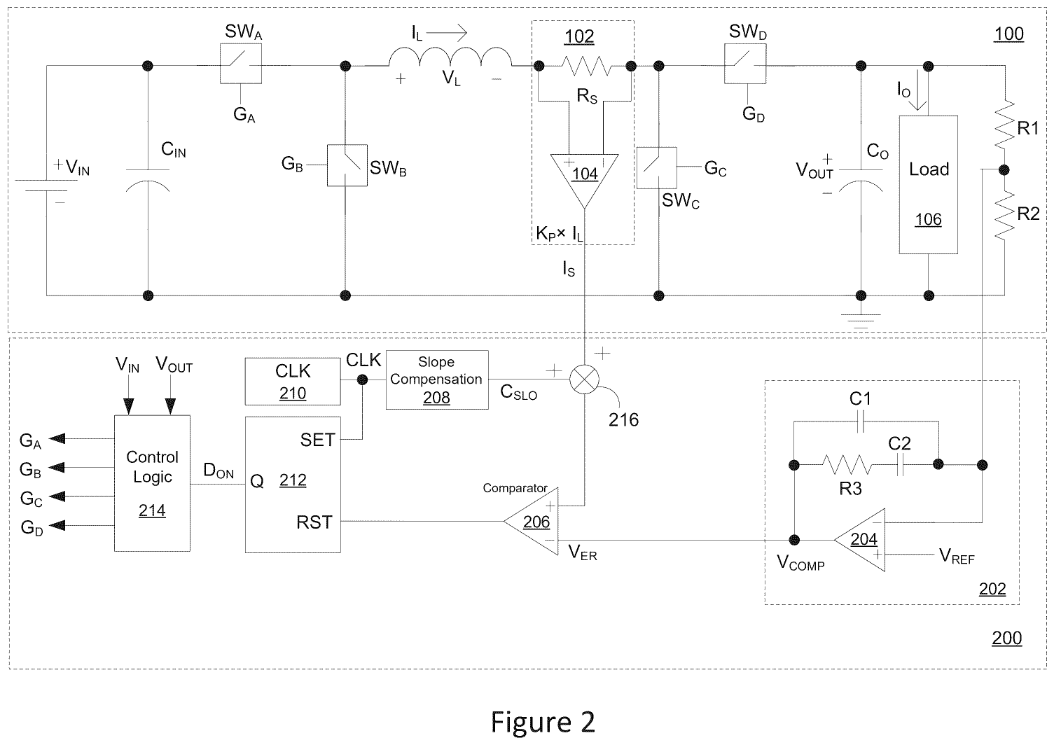

FIG. 2 illustrates a schematic diagram of a four-switch buck-boost converter with peak current mode control in accordance with various embodiments of the present disclosure. The four-switch buck-boost converter 100 comprises an input capacitor C_{IN}, a first high-side switch SW_{A}, a first low-side switch SW_{B}, a second low-side switch SW_{C}, a second high-side switch SW_{D}, an inductor and a current sense resistor R_{S} and an output capacitor C_{O}.

A dc voltage source is connected between an input voltage bus V_{IN} and ground. The input capacitor C_{IN} is connected in parallel with the de voltage source. A load 106 is connected between an output voltage bus V_{OUT} and ground. The output capacitor C_{O} is connected in parallel with the load 106.

The first high-side switch SW_{A} and the first low-side switch SW_{B} are connected in series between V_{IN} and ground. The first high-side switch SW_{A} is controlled by a gate drive signal G_{A}. The first low-side switch SW_{B} is controlled by a gate drive signal G_{B}. The second high-side switch SW_{D} and the second low-side switch SW_{C} are connected in series between V_{OUT} and ground. The second high-side switch SW_{D} is controlled by a gate drive signal G_{D}. The second low-side switch SW_{C} is controlled by a gate drive signal G_{C}. The inductor and the current sense resistor R_{S} are connected in series between a common node of the first high-side switch SW_{A} and the first low-side switch SW_{B}, and a common node of the second high-side switch SW_{D} and the second low-side switch SW_{C}.

In some embodiments, the controller 200 is a peak current mode PWM controller. As shown in FIG. 2, the controller 200 comprises a feedback control unit 202, a comparator 206, a summing point 216, a slope compensation unit 208, a clock generator 210, a latch 212 and a control logic unit 214.

The feedback control unit 202 comprises an error amplifier 204 and a compensation network. The compensation network comprises one resistor R3 and two capacitors C1, C2. The compensation network can create both a zero and a pole in the frequency response of the power converter 100. As shown in FIG. 2, the resistor R3 is connected in series with the capacitor C2 to form a series RC network. The capacitor C1 is connected in parallel with the series RC network. This compensation network is employed to stabilize the feedback loop of the power converter 100 by appropriately placing the zero and pole in the complex plane.

As shown in FIG. 2, an inverting input of the error amplifier 204 is connected to the output of the power converter 100 through a resistor divider formed by R1 and R2. A non-inverting input of the error amplifier 204 is configured to receive a predetermined reference V_{REF}. The error amplifier 204 is configured to generate a COMP signal V_{COMP}.

A current sense amplifier 104 has inputs connected to the terminals of the current sense resistor R_{S}, respectively. The current sense amplifier 104 is configured to generate a current sense signal I_{S}. I_{S} is equal to I_{L}×K_{P}. IL is the current flowing through the inductor of the power converter. K_{P} is a predetermined current sense gain.

At the summing point 216, the current sense signal I_{S} and a slope compensation signal C_{SLO} generated by the slope compensation unit 208 are added together and further fed into a non-inverting input of the comparator 206. An inverting input of the comparator 206 is configured to receive an error signal V_{ER}. In some embodiments, as shown in FIG. 2, the error signal V_{ER} is equal to the COMP signal V_{COMP}.

In operation, the clock signal CLK generated by the clock generator 210 is fed into the set input of the latch 212 to set the latch 212. Once the non-inverting input of the comparator 206 exceeds the inverting input of the comparator 206, the comparator 206 generates a logic high signal to reset the latch 212. The latch 212 generates a PWM signal Don fed into the control logic 214. Based on the PWM signal DON and the input and output voltages of the power converter 100, the control logic unit 214 is configured to generate the four gate drive signals G_{A}, G_{B}, G_{C} and G_{D} for controlling four switches SW_{A}, SW_{B}, SW_{C} and SW_{D} of the power converter 100, respectively.

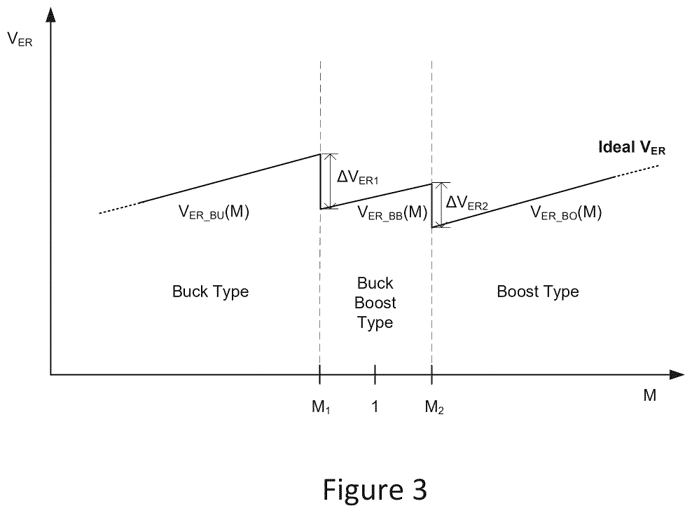

FIG. 3 illustrates the variation of the error signal under different operating modes in accordance with various embodiments of the present disclosure. The horizontal axis represents the voltage gain of the power converter. M is a ratio of the output voltage V_{OUT} to the input voltage V_{IN}. The vertical axis represents the error signal V_{ER}. M1 and M2 are predetermined constants. As shown in FIG. 3, M1 is less than 1, and M2 is greater than 1.

In operation, when M is less than M1, the power converter 100 is configured to operate in a buck operating mode. The error signal V_{ER} and M has a linear relationship in the buck operating mode. The error signal in the buck operating mode is denoted as V_{ER_BU}(M) as shown in FIG. 3.

In operation, when M is less than M2 and greater than M1, the power converter 100 is configured to operate in a buck-boost operating mode. The error signal V_{ER} and M has a linear relationship in the buck-boost operating mode. The error signal in the buck-boost operating mode is denoted as V_{ER_BB}(M) as shown in FIG. 3. The operating mode transition occurs at M1. At M1, the error signal drops significantly as shown in FIG. 3. The voltage drop of the error signal at M1 is denoted as ΔV_{ER1}.

In operation, when M is greater than M2, the power converter 100 is configured to operate in a boost operating mode. The error signal V_{ER} and M has a linear relationship in the boost operating mode. The error signal in the boost operating mode is denoted as V_{ER_BO}(M) as shown in FIG. 3. The operating mode transition occurs at M2. At M2, the error signal drops significantly as shown in FIG. 3. The voltage drop of the error signal at M2 is denoted as ΔV_{ER2}.

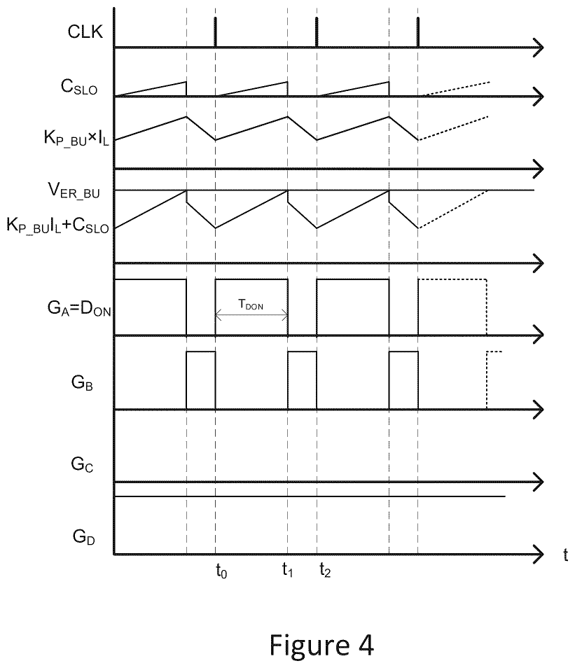

Based on the error signal shown in FIG. 3, the V_{ER}(M) equations under each operating modes will be derived below with respect to FIGS. 4-6. Based on the V_{ER} (M) equations, the voltage drops ΔV_{ER1} and ΔV_{ER2} can be obtained. After having ΔV_{ER1} and ΔV_{ER2}, a compensation method can be used to modify the COMP signal. More particularly, during a transition from the buck operating mode to the buck-boost operating mode at M1, ΔV_{ER1} is subtracted from the COMP signal to obtain the starting point of the error signal V_{ER_BB}(M). Likewise, during a transition from the buck-boost operating mode to the boost operating mode at M2, a sum of ΔV_{ER1} and ΔV_{ER2} is subtracted from the COMP signal to obtain the starting point of the error signal V_{ER_BO} (M). Such modifications help to achieve an ideal V_{ER}(M).

FIG. 4 illustrates various waveforms associated with the buck operating mode of the four-switch buck-boost converter in accordance with various embodiments of the present disclosure. The horizontal axis represents intervals of time. There are eight rows. The first row represents the clock signal CLK. The second row represents the slope compensation signal C_{SLO}. The third row represents the current sense signal K_{P_BU}×I_{L} under the buck operating mode. The fourth row represents the error signal V_{ER_BU} and a sum of the current sense signal K_{P_BU}×I_{L} and the slope compensation signal C_{SLO}. The fifth row represents the gate drive signal G_{A} of the first high-side switch SW_{A}. The sixth row represents the gate drive signal G_{B} of the first low-side switch SW_{B}. The seventh row represents the gate drive signal G_{C} of the second low-side switch SW_{C}. The eighth row represents the gate drive signal G_{D} of the second high-side switch SW_{D}.

In the buck operating mode, the current sense amplifier has a first gain. This gain is denoted as K_{P_BU}. The gate drive signal G_{A} is the same as the PWM signal D_{ON}. As shown in FIG. 4, the gate drive signal G_{B} is complementary with the gate drive signal G_{A}. The gate drive signal G_{C} is always low, and the gate drive signal G_{D} is always high.

At t0, when the clock signal CLK triggers the latch 212, the PWM signal D_{ON} turns high. In response to the change of the PWM signal D_{ON}, the gate drive signal G_{A} turns high, and the gate drive signal G_{B} turns low. Consequently, SW_{A} is turned on, and SW_{B} is turned off. From t0 to t1, the voltage V_{L} across the inductor is equal to the difference between the input voltage and the output voltage. From t0 to t1, this voltage difference magnetizes the inductor so that the current IL flowing through the inductor increases in a linear manner. From t0 to t1, the slope compensation signal C_{SLO} and the current sense signal K_{P_BU}×IL are added together. At t1, when the sum of the slope compensation signal C_{SLO} and the current sense signal K_{P_BU}×I_{L} is greater than the error signal V_{ER_BU}, the comparator triggers the latch 212. The PWM signal D_{ON} turns low at t1. In response to the change of the PWM signal D_{ON}, the gate drive signal G_{A} turns low, and the gate drive signal G_{B} turns high. Consequently, SW_{A} is turned off, and SW_{B} is turned on. At this time, the voltage V_{L} across the inductor is equal to −1×V_{OUT}. From t1 to t2, the output voltage demagnetizes the inductor so that the current IL flowing through the inductor decreases in a linear manner.

Based on the voltage-second balance theory, the equation of the error signal V_{ER_BU} (M) can be expressed as:

$${V}_{ER\_BU} ( M ) = {K}_{P\_BU} ( {I}_{O} + \frac{( 1 - {D}_{BU} ) {V}_{OUT}}{2 {F}_{SW} L} + \frac{{C}_{SLO} {D}_{BU}}{{F}_{SW}} ) \qquad ( 1 )$$

In Equation (1), D_{BU} is equal to M. Io is the output current of the four-switch buck-boost converter. F_{SW} is the switching frequency of the four-switch buck-boost converter. L is the inductance of the inductor.

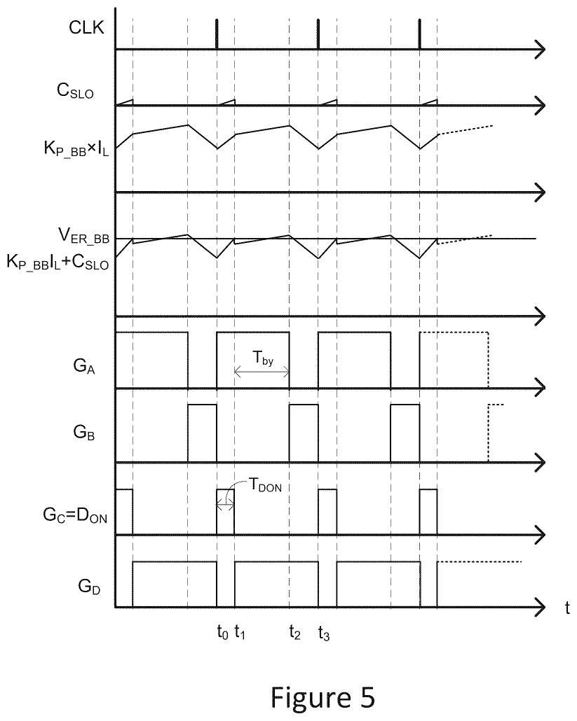

FIG. 5 illustrates various waveforms associated with the buck-boost operating mode of the four-switch buck-boost converter in accordance with various embodiments of the present disclosure. The horizontal axis represents intervals of time. There are eight rows. The first row represents the clock signal CLK. The second row represents the slope compensation signal C_{SLO}. The third row represents the current sense signal K_{P_BB}×I_{L} under the buck-boost operating mode. The fourth row represents the error signal V_{ER_BB} and a sum of the current sense signal K_{P_BB}×I_{L} and the slope compensation signal C_{SLO}. The fifth row represents the gate drive signal G_{A} of the first high-side switch SW_{A}. The sixth row represents the gate drive signal G_{B} of the first low-side switch SW_{B}. The seventh row represents the gate drive signal G_{C} of the second low-side switch SW_{C}. The eighth row represents the gate drive signal G_{D} of the second high-side switch SW_{D}.

In the buck-boost operating mode, the current sense amplifier has a second gain. This gain is denoted as K_{P_BB}. The gate drive signal G_{C} is the same as the PWM signal D_{ON}. As shown in FIG. 5, the gate drive signal G_{D} is complementary with the gate drive signal G_{C}. The leading edge of the gate drive signal G_{A} is aligned with the leading edge of the gate drive signal G_{C}. The gate drive signal G_{A} turns low after a fixed bypass time T_{by} counting from the falling edge of the gate drive signal G_{C}. The gate drive signal G_{B} is complementary with the gate drive signal G_{A}.

At t0, when the clock signal CLK triggers the latch 212, the PWM signal Don turns high. In response to the change of the PWM signal D_{ON}, the gate drive signal G_{C} and gate drive signal G_{A} turn high. The gate drive signal G_{D} and the gate drive signal G_{B} turn low. Consequently, SW_{C} and SW_{A} are turned on. SW_{D} and SW_{B} are turned off. From t0 to t1, the voltage V_{L} across the inductor is equal to the input voltage. The input voltage magnetizes the inductor so that the current IL flowing through the inductor increases in a linear manner. From t0 to t1, the slope compensation signal C_{SLO} and the current sense signal K_{P_BB}×I_{L} are added together. At t1, when the sum of the slope compensation signal C_{SLO} and the current sense signal K_{P_BB}×IL is greater than the error signal V_{ER_BB}, the comparator triggers the latch 212. The PWM signal Don turns low. In response to the change of the PWM signal D_{ON}, the gate drive signal G_{C} turns low, and the gate drive signal G_{D} turns high at t1. Consequently, SW_{C} is turned off, and SW_{D} is turned on.

From t1 to t2, the voltage V_{L} across the inductor is equal to the difference between the input voltage and the output voltage. From t1 to t2, this voltage difference magnetizes the inductor so that the current IL flowing through the inductor increases in a linear manner. At t2, the fixed bypass time T_{by} ends. The gate drive signal G_{A} turns low, and the gate drive signal G_{B} turns high. Consequently, SW_{A} is turned off, and SW_{B} is turned on. From t2 to t3, the voltage V_{L} across the inductor is equal to −V_{OUT}. The output voltage demagnetizes the inductor so that the current IL flowing through the inductor decreases in a linear manner from t2 to t3.

Based on the voltage-second balance theory, the equation of the error signal V_{ER_BB} (M) can be expressed as:

$${V}_{ER\_BB} ( M ) = {K}_{P\_BB} \{ \frac{{I}_{O}}{( 1 - {D}_{BB} )} + \frac{{V}_{OUT}}{{F}_{SW} L} [ \frac{{D}_{BB} ( 1 - {D}_{BB} - {F}_{SW} {T}_{by} )}{{D}_{BB} + {F}_{SW} {T}_{by}} - \frac{{( {F}_{SW} {T}_{by} )}^{2} ( 1 - 2 {D}_{BB} - {F}_{SW} {T}_{by} )}{2 ( 1 - {D}_{BB} ) ( {D}_{BB} + {F}_{SW} {T}_{by} )} - \frac{{( 1 - {D}_{BB} - {F}_{SW} {T}_{by} )}^{2}}{2 ( 1 - {D}_{BB} )} ] + \frac{{c}_{{SLO}^{{D}_{BB}}}}{{F}_{SW}} \} \qquad ( 2 )$$

In Equation (2), D_{BB} can be expressed by the following equation:

$${D}_{BB} = {T}_{DON} \times {F}_{SW} = \frac{M - {F}_{SW} \times {T}_{by}}{1 + M} \qquad ( 3 )$$

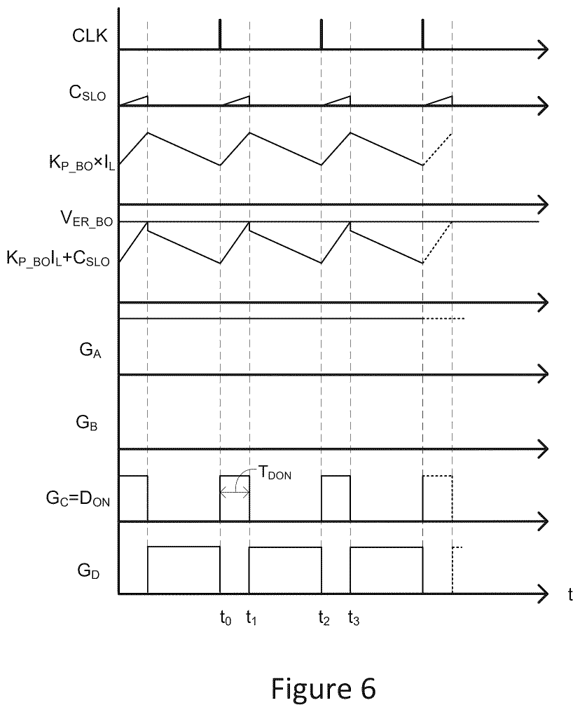

FIG. 6 illustrates various waveforms associated with the boost operating mode of the four-switch buck-boost converter in accordance with various embodiments of the present disclosure. There are eight rows. The first row represents the clock signal CLK. The second row represents the slope compensation signal C_{SLO}. The third row represents the current sense signal K_{P_BO}×I_{L} under the boost operating mode. The fourth row represents the error signal V_{ER_BO} and a sum of the current sense signal K_{P_BO}×I_{L} and the slope compensation signal C_{SLO}. The fifth row represents the gate drive signal G_{A} of the first high-side switch SW_{A}. The sixth row represents the gate drive signal G_{B} of the first low-side switch SW_{B}. The seventh row represents the gate drive signal G_{C} of the second low-side switch SW_{C}. The eighth row represents the gate drive signal G_{D} of the second high-side switch SW_{D}.

In the boost operating mode, the current sense amplifier has a third gain. This gain is denoted as K_{P_BO}. The gate drive signal G_{C} is the same as the PWM signal D_{ON}. As shown in FIG. 6, the gate drive signal G_{D} is complementary with the gate drive signal G_{C}. The gate drive signal G_{B} is always low, and the gate drive signal G_{A} is always high.

At t0, when the clock signal CLK triggers the latch 212, the PWM signal D_{ON} turns high. In response to the change of the PWM signal D_{ON}, the gate drive signal G_{C} turns high, and the gate drive signal G_{D} turns low. Consequently, SW_{C} is turned on, and SW_{D} is turned off. At this time, the voltage V_{L} across the inductor is equal to the input voltage. From t0 to t1, the input voltage magnetizes the inductor so that the current IL flowing through the inductor increases in a linear manner. From t0 to t1, the slope compensation signal C_{SLO} and the current sense signal K_{P_BO}×I_{L} are added together. At t1, when the sum of the slope compensation signal C_{SLO} and the current sense signal K_{P_BO}×I_{L} is greater than the error signal V_{ER_BO}, the comparator triggers the latch 212. The PWM signal Don turns low at t1. In response to the change of the PWM signal D_{ON}, the gate drive signal G_{C} turns low, and the gate drive signal G_{D} turns high. Consequently, SW_{C} is turned off, and SW_{D} is turned on. At this time, the voltage V_{L} across the inductor is equal to the difference between the input voltage and the output voltage. From t1 to t2, the difference (V_{IN}−V_{OUT}) demagnetizes the inductor so that the current IL flowing through the inductor decreases in a linear manner.

Based on the voltage-second balance theory, the equation of the error signal V_{ER_BO} (M) can be expressed as:

$${V}_{ER\_BO} ( M ) = {K}_{P\_BO} [ \frac{Io}{1 - {D}_{BO}} - \frac{{D}_{BO} ( 1 - {D}_{BO} ) {V}_{OUT}}{2 {F}_{SW} L} + \frac{{C}_{SLO} {D}_{BO}}{{F}_{SW}} ] \qquad ( 4 )$$

In Equation (4), D_{BO} can be expressed by the following equation:

$${D}_{BO} = {T}_{DON} \times {F}_{SW} = 1 - \frac{1}{M} \qquad ( 5 )$$

Referring back to FIG. 3, ΔV_{ER1} is the voltage difference between V_{ER_BU} (M1) and the V_{ER}_BB (M1). According to Equations (1) and (2), ΔV_{ER1} can be expressed as:

$$Δ {V}_{ER 1} = {V}_{ER\_BB} ( {M}_{1} ) - {V}_{ER\_BU} ( {M}_{1} ) = {α}_{1} {I}_{O} + {β}_{1} {V}_{OUT} + {γ}_{1} \frac{{c}_{SLO}}{{F}_{SW}} \qquad ( 6 )$$

In Equation (6), α₁ can be expressed as:

$${α}_{1} = \frac{{K}_{P\_BB}}{( 1 \frac{{M}_{1} - {F}_{SW} {T}_{by}}{1 + M1 + {M}_{1}} )} - {K}_{P\_BU} \qquad ( 7 )$$

In Equation (6), β₁ can be expressed as:

$${β}_{1} = \frac{{K}_{P \_ BB}}{2 {F}_{S W} L} [ \frac{2 \frac{{M}_{1} − {F}_{S W} {T}_{by}}{1 + {M}_{1}} ( 1 − \frac{{M}_{1} − {F}_{S W} {T}_{by}}{1 + {M}_{1}} {F}_{S W} {T}_{by} )}{\frac{{M}_{1} − {F}_{S W} {T}_{by}}{1 + {M}_{1}} + {F}_{S W} {T}_{b y}} − \frac{{( {F}_{S W} {T}_{by} )}^{2} ( 1 − 2 \frac{{M}_{1} − {F}_{S W} {T}_{by}}{1 + {M}_{1}} {F}_{S W} {T}_{by} )}{( 1 − \frac{{M}_{1} − {F}_{S W} {T}_{by}}{1 + {M}_{1}} ) ( \frac{{M}_{1} − {F}_{S W} {T}_{by}}{1 + {M}_{1}} + {F}_{S W} {T}_{by} )} − \frac{{( 1 − \frac{{M}_{1} − {F}_{S W} {T}_{by}}{1 + {M}_{1}} − {F}_{S W} {T}_{by} )}^{2}}{( 1 − \frac{{M}_{1} − {F}_{S W} {T}_{by}}{1 + {M}_{1}} )} − \frac{{K}_{P \_ BU} ( 1 − {M}_{1} )}{2 {F}_{S W} L} \qquad ( 8 )$$

In Equation (6), γ₁ can be expressed as:

$${γ}_{1} = {K}_{P\_BB} \frac{{M}_{1} - {F}_{S W} {T}_{by}}{1 + {M}_{1}} - {K}_{P \_ BU} {M}_{1} \qquad ( 9 )$$

Referring back to FIG. 3, ΔV_{ER2} is the voltage difference between V_{ER_BB} (M2) and the V_{ER_BO} (M2). According to equations (2) and (4), ΔV_{ER2} can be expressed as:

$$Δ {V}_{ER 2} = {V}_{ER \_ BO} ( {M}_{2} ) - {V}_{ER \_ BB} ( {M}_{2} ) = {α}_{2} {I}_{O} + {β}_{2} {V}_{O U T} + {γ}_{2} \frac{{c}_{SLO}}{{F}_{SW}} \qquad ( 10 )$$

In Equation (10), α₂ can be expressed as:

$${α}_{2} = {K}_{P \_ BO} - \frac{{K}_{P B B}}{( 1 \frac{{M}_{{2}^{- F} {SW}^{T} by}}{1 + {M}_{2}} )} \qquad ( 11 )$$

In Equation (10), β₂ can be expressed as:

$${β}_{2} = \frac{{K}_{P \_ BO} \frac{{M}_{2} − 1}{{M}_{2}^{2}}}{2 {F}_{SW} L} − \frac{{K}_{P \_ BB}}{2 {F}_{S W} L} [ \frac{2 \frac{{M}_{2} − {F}_{S {W}^{T}} {T}_{by}}{1 + {M}_{2}} ( 1 − \frac{{M}_{2} − {F}_{S {W}^{T}} {T}_{by}}{1 + {M}_{2}} − {F}_{S W} {T}_{by} )}{\frac{{M}_{2} − {F}_{S {W}^{T}} {T}_{by}}{1 + {M}_{2}} + {F}_{S W} {T}_{by}} − \frac{{( {F}_{S {W}^{T}} {T}_{by} )}^{2} ( 1 − 2 \frac{{M}_{2} − {F}_{S {W}^{T}} {T}_{by}}{1 + {M}_{2}} − {F}_{S W} {T}_{by} )}{( 1 − \frac{{M}_{2} − {F}_{S {W}^{T}}}{1 + {M}_{2}} ) ( \frac{{M}_{1} − {F}_{S {W}^{T}} {T}_{by}}{1 + {M}_{2}} + {F}_{S W} {T}_{by} )} − \frac{{( 1 − \frac{{M}_{2} − {F}_{S {W}^{T}} {T}_{by}}{1 + {M}_{2}} − {F}_{S W} {T}_{by} )}^{2}}{( 1 − \frac{{M}_{1} − {F}_{S {W}^{T}} {T}_{by}}{1 + {M}_{2}} )} ] \qquad ( 12 )$$

In Equation (10), γ₂ can be expressed as:

$${γ}_{2} = {K}_{P \_ BO} ( 1 - \frac{1}{{M}_{2}} ) - {K}_{P \_ BB} \frac{{M}_{2} - {F}_{S W} {T}_{by}}{1 + {M}_{2}} \qquad ( 13 )$$

In order to eliminate I_{O} in equations (6) and (10) so as to simplify ΔV_{ER1} and ΔV_{ER2}, K_{P_BB} and K_{P_BO} can be defined as:

$${K}_{P \_ BB} = {K}_{P \_ BBsim} = {K}_{P \_ BU} ( \frac{1 + {F}_{S W} {T}_{by}}{1 + {M}_{1}} ) \qquad ( 14 )$$

$${K}_{P \_ BO} = {K}_{P \_ BOsim} = {K}_{P \_ BB} \frac{1 + {M}_{2}}{{M}_{2} ( 1 + {F}_{S W} {T}_{by} )} = {K}_{P \_ BU} \frac{1 + {M}_{2}}{{M}_{2} ( 1 + {M}_{1} )} \qquad ( 15 )$$

Based on equations (6), (7) and (14), ΔV_{ER1} can be simplified as:

$$Δ {V}_{ER 1} = {β}_{1 sim} {V}_{O U T} + {γ}_{1 sim} \qquad ( 16 )$$

In Equation (16), β₁ₛᵢₘ can be expressed as:

$${β}_{1 sim} = \frac{{K}_{P \_ BU}}{2 {F}_{S W} L} \{ \frac{\begin{matrix}3 {{D}_{BBM 1} ( 1 - {D}_{BBM 1} )}^{2} + {D}_{BBM 1} {F}_{SW} {T}_{by} + \\ 5 {D}_{BBM 1} - 6 ) + {F}_{S W} {T}_{by} ( 1 - {F}_{S W} {T}_{by} )\end{matrix}}{{D}_{BBM 1} + {F}_{SW} {T}_{by}} - 1 + {M}_{1} \} \qquad ( 17 )$$

In Equation (16), γ₁ₛᵢₘ can be expressed as:

$${γ}_{1 sim} = \frac{{C}_{SLO}}{F s W} [ {D}_{BBM 1} ( 1 - {D}_{BBM 1} ) - {M}_{1} ] \qquad ( 18 )$$

In Equations (17) and (18), D_{BBM1} can be expressed as:

$${D}_{BBM 1} = \frac{{M}_{1} - {F}_{S W} {T}_{by}}{1 + {M}_{1}} \qquad ( 19 )$$

Based on equations (10), (11) and (15), ΔV_{ER2} can be simplified as follow:

$$Δ {V}_{ER 2} = {β}_{2 sim} {V}_{O U T} + {γ}_{2 sim} \qquad ( 20 )$$

In Equation (20), β₂ₛᵢₘ can be expressed as:

$${β}_{2 sim} = \frac{{K}_{P \_ BB}}{2 {F}_{S W} L} \{ \frac{{M}_{2} - 1}{{M}_{2}^{3} ( 1 - {D}_{BBM 2} )} - \frac{\begin{matrix}3 {D}_{BBM 2} {( 1 - {D}_{BBM 2} )}^{2} + {D}_{BBM 2} {F}_{S W} {T}_{by} ( {F}_{SW} {T}_{by} + \\ 5 {D}_{BBM 2} - 6 ) + {F}_{S W} {T}_{by} ( 1 - {F}_{S W} {T}_{by} )\end{matrix}}{( 1 - {D}_{BBM 2} ) ( {D}_{BBM 2} + {F}_{SW} {T}_{by} )} \} \qquad ( 21 )$$

In Equation (20), γ₂ₛᵢₘ can be expressed as:

$${γ}_{2 sim} = \frac{{c}_{SLO}}{{F}_{SW}} [ \frac{{M}_{2} - 1}{{M}_{2}^{2}} {D}_{BBM 1} - {D}_{BBM 2} ] \qquad ( 22 )$$

In Equations (21) and (22), D_{BBM2} can be expressed as:

$${D}_{BBM 2} = \frac{{M}_{2} - {F}_{S W} {T}_{by}}{1 + {M}_{2}} \qquad ( 23 )$$

In order to achieve an ideal error signal during operating mode transitions, a variable gain amplifier is employed to replace the current sense amplifier 104. The variable gain amplifier is able to provide different current sense gains according to Equations (14) and (15). Furthermore, an offset generator is employed to provide ΔV_{ER1} and ΔV_{ER2}.

In operation, when M is less than M1, the four-switch buck-boost converter is configured to operate in the buck operating mode. The current sense gain is equal to K_{P_BU}. The offset voltage is equal to zero. The error signal is equal to the COMP signal.

In operation, when M is greater than M1 and less than M2, the four-switch buck-boost converter is configured to operate in the buck-boost operating mode. The current sense gain is equal to K_{P_BBsim} as defined by Equation (14). The offset voltage is equal to ΔV_{ER1}. The error signal is equal to the COMP signal minus ΔV_{ER1}.

In operation, when M is greater than M2, the four-switch buck-boost converter is configured to operate in the boost operating mode. The current sense gain is equal to K_{P_BOsim} as defined by Equation (15). The offset voltage is equal to a sum of ΔV_{ER1} and ΔV_{ER2}. The error signal is equal to the COMP signal minus the sum of ΔV_{ER1} and ΔV_{ER2}.

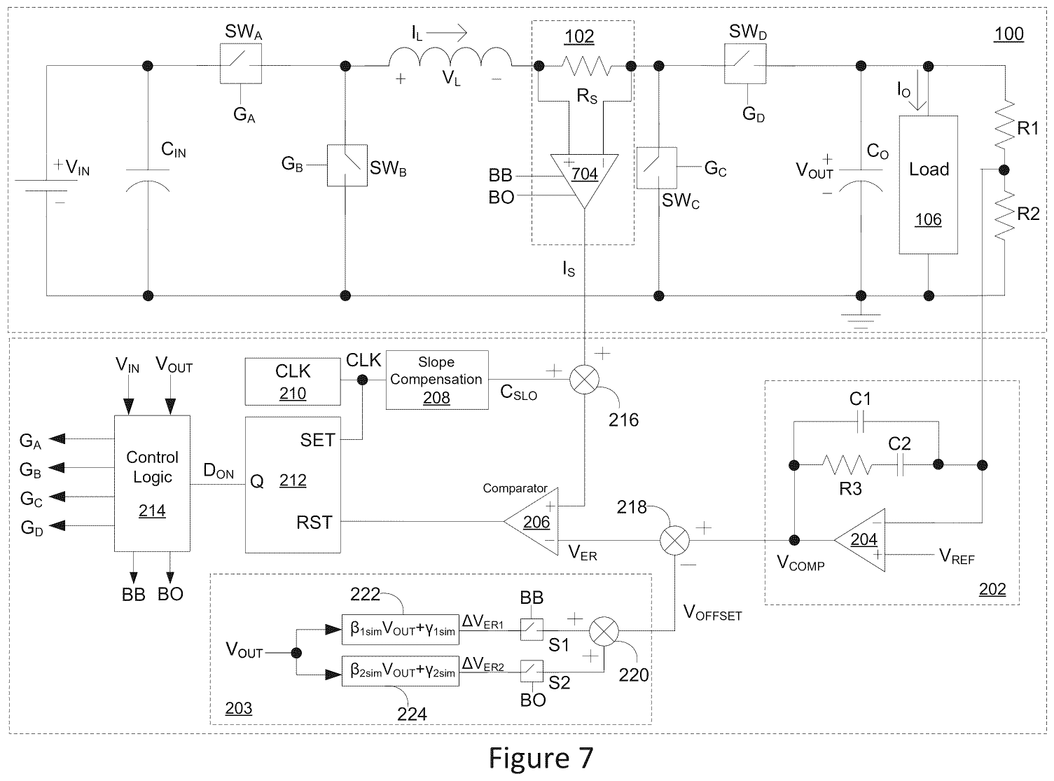

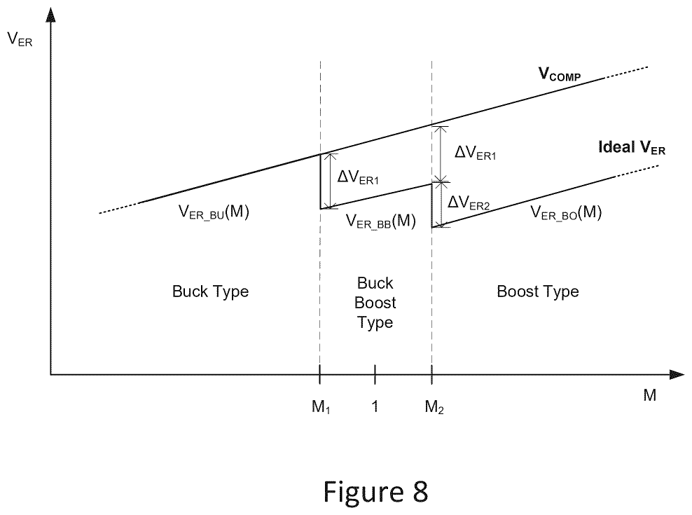

FIG. 7 illustrates a schematic diagram of a four-switch buck-boost converter and a peak current mode controller in accordance with various embodiments of the present disclosure. The schematic diagram shown in FIG. 7 is similar to that shown in FIG. 2 except that a variable gain amplifier 704 is employed to replace the current sense amplifier 104 shown in FIG. 2. Furthermore, an offset generator 203 is employed to generate ΔV_{ER1} and ΔV_{ER2}. A summing point 218 is also added. At the summing point 218, the offset voltage VOFFSET is subtracted from the COMP signal to achieve the ideal error signal (shown in FIG. 8). More particularly, during an operating mode transition from a buck operating mode to a buck-boost operating mode, ΔV_{ER1} is subtracted from the COMP signal to obtain the error signal V_{ER} fed into the inverting input of the comparator 206. During an operating mode transition from a buck-boost operating mode to a boost operating mode, a sum of ΔV_{ER1} and ΔV_{ER2} is subtracted from the COMP signal to obtain the error signal V_{ER} fed into the inverting input of the comparator 206.

The control logic unit 214 has an input connected to an output of the latch 212. In operation, the control logic unit 214 is configured to generate four gate drive signals for controlling four switches SW_{A}, SW_{B}, SW_{C} and SW_{D}, respectively. Furthermore, the control logic unit 214 is configured to receive an input voltage V_{IN} and an output voltage V_{OUT} of the four-switch buck-boost converter, and generate a first control signal BB indicative of a buck-boost operating mode of the four-switch buck-boost converter, and a second control signal BO indicative of a boost operating mode of the four-switch buck-boost converter.

The offset generator 203 comprises a first offset processing unit 222, a first control switch S1, a second offset processing unit 224, a second control switch S2 and a summing point 220. As shown in FIG. 7, the first offset processing unit 222 and the first control switch S1 are connected in series. The first control switch S1 is controlled by the first control signal BB generated by the control logic unit 214. The second offset processing unit 224 and the second control switch S2 are connected in series. The second control switch S2 is controlled by the second control signal BO generated by the control logic unit 214.

As shown in FIG. 7, an input of the first offset processing unit 222 is configured to receive the output voltage V_{OUT} of the four-switch buck-boost converter. The output of the first offset processing unit 222 is configured to generate a first offset voltage ΔV_{ER1} according to Equation (16). The output of the first offset processing unit 222 is connected to a first input of the summing point 220 through the first control switch S1. An input of the second offset processing unit 224 is configured to receive the output voltage V_{OUT} of the four-switch buck-boost converter. An output of the second offset processing unit 224 is configured to generate a second offset voltage ΔV_{ER2} according to Equation (20). The output of the second offset processing unit 224 is connected to a second input of the summing point 220 through the second control switch S2.

In operation, in response to a buck operating mode of the four-switch buck-boost converter, both the first control switch S1 and the second control switch S2 are turned off. As a result of turning off both the first control switch S1 and the second control switch S2, the offset voltage V_{OFFSET} generated by the offset generator 203 is equal to zero. The error signal V_{ER} is equal to the COMP signal.

In operation, in response to a buck-boost operating mode of the four-switch buck-boost converter, the first control switch S1 is turned on and the second control switch S2 is turned off. As a result of turning on the first control switch S1 and turning off the second control switch S2, the offset voltage V_{OFFSET} generated by the offset generator 203 is equal to the first offset voltage ΔV_{ER1}. The first offset voltage ΔV_{ER1} is subtracted from the COMP signal to obtain the error signal V_{ER} in the buck-boost operating mode.

In operation, in response to a boost operating mode of the four-switch buck-boost converter, both the first control switch S1 and the second control switch S2 are turned on. As a result of turning on both the first control switch S1 and the second control switch S2, the offset voltage VOFFSET generated by the offset generator 203 is equal to a sum of the first offset voltage ΔV_{ER1} and the second offset voltage ΔV_{ER2}. The sum of the first offset voltage ΔV_{ER1} and the second offset voltage ΔV_{ER2} is subtracted from the COMP signal to obtain the error signal in the boost operating mode.

The variable gain amplifier 704 has a non-inverting input connected to a first terminal of the current sense resistor R_{S}, an inverting input connected to a second terminal of the current sense resistor R_{S}, and an output configured to generate the current sense signal I_{S}. As shown in FIG. 7, the variable gain amplifier 704 is controlled by the first control signal BB and the second control signal BO. The first control signal BB and the second control signal BO are configured such that the variable gain amplifier 704 is able to generate three different gains in response to three different operating modes.

In operation, in response to the buck operating mode of the four-switch buck-boost converter, the variable gain amplifier 704 is configured to amplify the current flowing through current sense resistor R_{S} to generate a first amplified current sense signal having a first gain. The first gain is K_{P_BU}.

In operation, in response to the buck-boost operating mode of the four-switch buck-boost converter, the variable gain amplifier 704 is configured to amplify the current flowing through current sense resistor R_{S} to generate a second amplified current sense signal having a second gain. The second gain is the current sense gain defined by Equation (14).

In operation, in response to the boost operating mode of the four-switch buck-boost converter, the variable gain amplifier 704 is configured to amplify the current flowing through current sense resistor R_{S} to generate a third amplified current sense signal having a third gain. The third gain is the current sense gain defined by Equation (15).

FIG. 8 illustrates the variations of the COMP signal and the error signal under different operating modes in accordance with various embodiments of the present disclosure. The horizontal axis represents the voltage gain of the power converter. M is a ratio of the output voltage to the input voltage. The vertical axis represents the error signal V_{ER}. M1 and M2 are predetermined constants. As shown in FIG. 8, M1 is less than 1, and M2 is greater than 1.

In operation, when M is less than M1, the power converter is configured to operate in a buck operating mode. The error signal V_{ER} and M has a linear relationship in the buck operating mode. The error signal in the buck operating mode is denoted as V_{ER} BU (M) as shown in FIG. 8. In the buck operating mode, the error signal and the COMP signal overlap each other. The offset is equal to zero.

In operation, when M is less than M2 and greater than M1, the power converter is configured to operate in a buck-boost operating mode. The error signal V_{ER} and M has a linear relationship in the buck-boost operating mode. The error signal in the buck-boost operating mode is denoted as V_{ER_BB}(M) as shown in FIG. 8. In the buck-boost operating mode, there is a voltage drop between the COMP signal and error signal. The voltage drop is equal to ΔV_{ER1}.

In operation, when M is greater than M2, the power converter is configured to operate in a boost operating mode. The error signal V_{ER} and M has a linear relationship in the boost operating mode. The error signal in the boost operating mode is denoted as V_{ER_BO} (M) as shown in FIG. 8. In the boost operating mode, there is a voltage drop between the COMP signal and error signal. The voltage drop is equal to a sum of ΔV_{ER1} and ΔV_{ER2}.

In order to achieve an ideal error signal, in the buck-boost operating mode, ΔV_{ER1} is subtracted from the COMP signal to obtain the ideal error signal. Likewise, in the boost operating mode, a sum of ΔV_{ER1} and ΔV_{ER2} is subtracted from the COMP signal to obtain the ideal error signal.

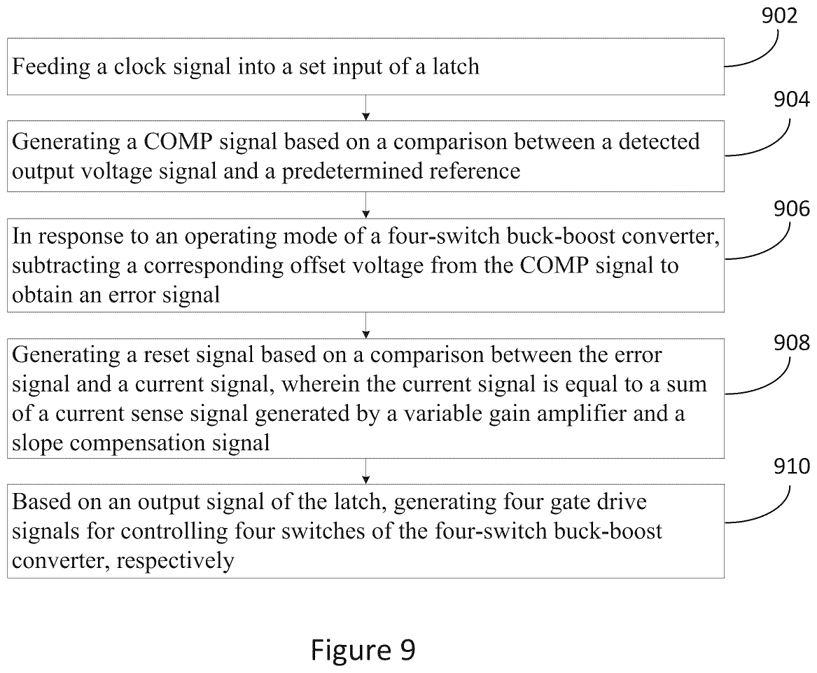

FIG. 9 illustrates a flow chart of a method for controlling the four-switch buck-boost converter shown in FIG. 7 in accordance with various embodiments of the present disclosure. This flowchart shown in FIG. 9 is merely an example, which should not unduly limit the scope of the claims. One of ordinary skill in the art would recognize many variations, alternatives, and modifications. For example, various steps illustrated in FIG. 9 may be added, removed, replaced, rearranged and repeated.

At step 902, a clock signal is fed into a set input of a latch.

At step 904, a COMP signal is generated based on a comparison between a detected output voltage signal and a predetermined reference.

At step 906, in response to an operating mode of a four-switch buck-boost converter, a corresponding offset voltage is subtracted from the COMP signal to obtain an error signal.

At step 908, a reset signal is generated based on a comparison between the error signal and a current signal, wherein the current signal is equal to a sum of a current sense signal generated by a variable gain amplifier and a slope compensation signal.

At step 910, based on an output signal of the latch, four gate drive signals for controlling four switches of the four-switch buck-boost converter, respectively are generated.

The offset generator comprises a first offset processing unit, a first control switch, a second offset processing unit and a second control switch, and wherein the first offset processing unit and the first control switch are connected in series, the second offset processing unit and the second control switch are connected in series, an input of the first offset processing unit is configured to receive the output voltage of the power converter, an output of the first offset processing unit is configured to generate a first offset voltage, an input of the second offset processing unit is configured to receive the output voltage of the power converter, and an output of the second offset processing unit is configured to generate a second offset voltage.

The method further comprises in response to a buck operating mode, turning off both the first control switch and the second control switch, and wherein as a result of turning off both the first control switch and the second control switch, the error signal is equal to the COMP signal in the buck operating mode, in response to a buck-boost operating mode, turning on the first control switch and turning off the second control switch, and wherein as a result of turning on the first control switch and turning off the second control switch, the first offset voltage is subtracted from the COMP signal to obtain the error signal in the buck-boost operating mode, and in response to a boost operating mode, turning on both the first control switch and the second control switch, and wherein as a result of turning on both the first control switch and the second control switch, a sum of the first offset voltage and the second offset voltage is subtracted from the COMP signal to obtain the error signal in the boost operating mode.

The four-switch buck-boost converter comprises a first high-side switch, a first low-side switch, a second high-side switch, a second low-side switch, an inductor and a current sense resistor, and wherein the inductor and the current sense resistor are connected in series between a common node of the first high-side switch and the first low-side switch, and a common node of the second high-side switch and the second low-side switch, and the variable gain amplifier has a non-inverting input connected to a first terminal of the current sense resistor, an inverting input connected to a second terminal of the current sense resistor, and an output configured to generate the current sense signal.

The method further comprises in response to a buck operating mode of the four-switch buck-boost converter, configuring the variable gain amplifier to amplify a current flowing through the current sense resistor to generate a first amplified current sense signal having a first gain, in response to a buck-boost operating mode of the four-switch buck-boost converter, configuring the variable gain amplifier to amplify the current flowing through the current sense resistor to generate a second amplified current sense signal having a second gain, and in response to a boost operating mode of the four-switch buck-boost converter, configuring the variable gain amplifier to amplify the current flowing through the current sense resistor to generate a third amplified current sense signal having a third gain.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to the present disclosure. Accordingly, the appended claims are intended to include within their scope such processes, machines, manufacture, compositions of matter, means, methods, or steps.

1. An apparatus comprising:
a clock generator configured to generate a set signal fed into a set input of a latch;
an error amplifier configured to generate a COMP signal;
an offset generator configured to generate different offset voltages; and
a comparator configured to generate a reset signal fed into a reset input of the latch, wherein:
a non-inverting input of the comparator is configured to receive a signal equal to a sum of a current sense signal and a slope compensation signal, and wherein the current sense signal is equal to a current flowing through a power converter times an adjustable gain; and
an inverting input of the comparator is configured to receive an error signal, and wherein the error signal is equal to the COMP signal minus an offset voltage generated by the offset generator.

2. The apparatus of claim 1, wherein the power converter is a four-switch buck-boost converter comprising:
a first high-side switch and a first low-side switch connected in series between an input voltage bus and ground;
a second high-side switch and a second low-side switch connected in series between an output voltage bus and ground; and
an inductor and a current sense resistor connected in series between a common node of the first high-side switch and the first low-side switch, and a common node of the second high-side switch and the second low-side switch.

3. The apparatus of claim 2, further comprising:
a variable gain amplifier having a non-inverting input connected to a first terminal of the current sense resistor, an inverting input connected to a second terminal of the current sense resistor, and an output configured to generate the current sense signal.

4. The apparatus of claim 3, wherein:
in response to a buck operating mode of the power converter, the variable gain amplifier is configured to amplify the current flowing through the power converter to generate a first amplified current sense signal having a first gain;
in response to a buck-boost operating mode of the power converter, the variable gain amplifier is configured to amplify the current flowing through the power converter to generate a second amplified current sense signal having a second gain; and
in response to a boost operating mode of the power converter, the variable gain amplifier is configured to amplify the current flowing through the power converter to generate a third amplified current sense signal having a third gain.

5. The apparatus of claim 1, further comprising:
a control logic unit having an input connected to an output of the latch, wherein the control logic unit is configured to generate four gate drive signals for controlling four switches of the power converter, respectively.

6. The apparatus of claim 5, wherein:
the control logic unit is configured to receive an input voltage and an output voltage of the power converter, and generate a first control signal indicative of a buck-boost operating mode of the power converter and a second control signal indicative of a boost operating mode of the power converter.

7. The apparatus of claim 6, wherein:
the offset generator comprises a first offset processing unit, a first control switch, a second offset processing unit, a second control switch and a summing point, and wherein:
the first offset processing unit and the first control switch are connected in series, wherein the first control switch is controlled by the first control signal generated by the control logic unit;
the second offset processing unit and the second control switch are connected in series, wherein the second control switch is controlled by the second control signal generated by the control logic unit;
an input of the first offset processing unit is configured to receive the output voltage of the power converter;
an output of the first offset processing unit is configured to generate a first offset voltage, and wherein the output of the first offset processing unit is connected to a first input of the summing point through the first control switch;
an input of the second offset processing unit is configured to receive the output voltage of the power converter; and
an output of the second offset processing unit is configured to generate a second offset voltage, and wherein the output of the second offset processing unit is connected to a second input of the summing point through the second control switch.

8. The apparatus of claim 7, wherein:
in response to a buck operating mode, both the first control switch and the second control switch are turned off, and wherein as a result of turning off both the first control switch and the second control switch, the error signal is equal to the COMP signal in the buck operating mode;
in response to the buck-boost operating mode, the first control switch is turned on and the second control switch is turned off, and wherein as a result of turning on the first control switch and turning off the second control switch, the first offset voltage is subtracted from the COMP signal to obtain the error signal in the buck-boost operating mode; and
in response to the boost operating mode, both the first control switch and the second control switch are turned on, and wherein as a result of turning on both the first control switch and the second control switch, a sum of the first offset voltage and the second offset voltage is subtracted from the COMP signal to obtain the error signal in the boost operating mode.

9. The apparatus of claim 7, further comprising:
a first summing point at which the current sense signal and the slope compensation signal are added together; and
a second summing point at which the offset voltage is subtracted from the COMP signal.

10. The apparatus of claim 1, wherein:
an inverting input of the error amplifier is connected to an output of the power converter through a resistor divider;
a non-inverting input of the error amplifier is configured to receive a predetermined reference voltage; and
a compensation network is connected between the inverting input of the error amplifier and an output of the error amplifier.

11. A system comprising:
a four-switch buck-boost converter comprising a first high-side switch, a first low-side switch, a second high-side switch, a second low-side switch and an inductor; and
a controller configured to generate four gate drive signals for controlling four switches of the four-switch buck-boost converter, respectively, wherein the controller comprises:
a clock generator configured to generate a set signal fed into a set input of a latch;
an error amplifier configured to generate a COMP signal;
an offset generator configured to generate different offset voltages; and
a comparator configured to generate a reset signal fed into a reset input of the latch, wherein:
a non-inverting input of the comparator is configured to receive a signal equal to a sum of a current sense signal and a slope compensation signal, and wherein the current sense signal is equal to a current flowing through the inductor times an adjustable gain; and
an inverting input of the comparator is configured to receive an error signal, and wherein the error signal is equal to the COMP signal minus an offset voltage generated by the offset generator.

12. The system of claim 11, further comprising a current sense resistor, wherein:
the first high-side switch and the first low-side switch are connected in series between an input voltage bus and ground;
the second high-side switch and the second low-side switch are connected in series between an output voltage bus and ground; and
the inductor and the current sense resistor connected in series between a common node of the first high-side switch and the first low-side switch, and a common node of the second high-side switch and the second low-side switch.

13. The system of claim 12, further comprising:
a variable gain amplifier having a non-inverting input connected to a first terminal of the current sense resistor, an inverting input connected to a second terminal of the current sense resistor, and an output configured to generate the current sense signal, wherein:
in response to a buck operating mode of the four-switch buck-boost converter, the variable gain amplifier is configured to amplify the current flowing through the inductor to generate a first amplified current sense signal having a first gain;
in response to a buck-boost operating mode of the four-switch buck-boost converter, the variable gain amplifier is configured to amplify the current flowing through the inductor to generate a second amplified current sense signal having a second gain; and
in response to a boost operating mode of the four-switch buck-boost converter, the variable gain amplifier is configured to amplify the current flowing through the inductor to generate a third amplified current sense signal having a third gain.

14. The system of claim 11, further comprising:
a control logic unit having an input connected to an output of the latch, wherein the control logic unit is configured to generate the four gate drive signals for controlling four switches of the four-switch buck-boost converter, respectively, wherein the control logic unit is configured to receive an input voltage and an output voltage of the four-switch buck-boost converter, and generate a first control signal indicative of a buck-boost operating mode of the four-switch buck-boost converter and a second control signal indicative of a boost operating mode of the four-switch buck-boost converter.

15. The system of claim 14, wherein:
the offset generator comprises a first offset processing unit and a first control switch connected in series, and a second offset processing unit and a second control switch connected in series, and wherein:
in response to a buck operating mode of the four-switch buck-boost converter, both the first control switch and the second control switch are turned off, and wherein as a result of turning off both the first control switch and the second control switch, the error signal is equal to the COMP signal in the buck operating mode;
in response to a buck-boost operating mode of the four-switch buck-boost converter, the first control switch is turned on and the second control switch is turned off, and wherein as a result of turning on the first control switch and turning off the second control switch, a first offset voltage generated by the first offset processing unit is subtracted from the COMP signal to obtain the error signal in the buck-boost operating mode; and
in response to a boost operating mode of the four-switch buck-boost converter, both the first control switch and the second control switch are turned on, and wherein as a result of turning on both the first control switch and the second control switch, a sum of the first offset voltage generated by the first offset processing unit and a second offset voltage generated by the second offset processing unit is subtracted from the COMP signal to obtain the error signal in the boost operating mode.

16. A method comprising:
feeding a clock signal into a set input of a latch;
generating a COMP signal based on a comparison between a detected output voltage signal and a predetermined reference;
in response to an operating mode of a four-switch buck-boost converter, subtracting a corresponding offset voltage from the COMP signal to obtain an error signal, wherein the corresponding offset voltage is generated by an offset generator;
generating a reset signal based on a comparison between the error signal and a current signal, wherein the current signal is equal to a sum of a current sense signal generated by a variable gain amplifier and a slope compensation signal; and
based on an output signal of the latch, generating four gate drive signals for controlling four switches of the four-switch buck-boost converter, respectively.

17. The method of claim 16, wherein:
the offset generator comprises a first offset processing unit, a first control switch, a second offset processing unit and a second control switch, and wherein:
the first offset processing unit and the first control switch are connected in series;
the second offset processing unit and the second control switch are connected in series;
an input of the first offset processing unit is configured to receive an output voltage of the four-switch buck-boost converter;
an output of the first offset processing unit is configured to generate a first offset voltage;
an input of the second offset processing unit is configured to receive the output voltage of the four-switch buck-boost converter; and
an output of the second offset processing unit is configured to generate a second offset voltage.

18. The method of claim 17, further comprising:
in response to a buck operating mode, turning off both the first control switch and the second control switch, and wherein as a result of turning off both the first control switch and the second control switch, the error signal is equal to the COMP signal in the buck operating mode;
in response to a buck-boost operating mode, turning on the first control switch and turning off the second control switch, and wherein as a result of turning on the first control switch and turning off the second control switch, the first offset voltage is subtracted from the COMP signal to obtain the error signal in the buck-boost operating mode; and
in response to a boost operating mode, turning on both the first control switch and the second control switch, and wherein as a result of turning on both the first control switch and the second control switch, a sum of the first offset voltage and the second offset voltage is subtracted from the COMP signal to obtain the error signal in the boost operating mode.

19. The method of claim 16, wherein:
the four-switch buck-boost converter comprises a first high-side switch, a first low-side switch, a second high-side switch, a second low-side switch, an inductor and a current sense resistor, and wherein the inductor and the current sense resistor are connected in series between a common node of the first high-side switch and the first low-side switch, and a common node of the second high-side switch and the second low-side switch; and
the variable gain amplifier has a non-inverting input connected to a first terminal of the current sense resistor, an inverting input connected to a second terminal of the current sense resistor, and an output configured to generate the current sense signal.

20. The method of claim 19, further comprising:
in response to a buck operating mode of the four-switch buck-boost converter, configuring the variable gain amplifier to amplify a current flowing through the current sense resistor to generate a first amplified current sense signal having a first gain;
in response to a buck-boost operating mode of the four-switch buck-boost converter, configuring the variable gain amplifier to amplify the current flowing through the current sense resistor to generate a second amplified current sense signal having a second gain; and
in response to a boost operating mode of the four-switch buck-boost converter, configuring the variable gain amplifier to amplify the current flowing through the current sense resistor to generate a third amplified current sense signal having a third gain.
